(19) United States
(12) Patent Application Publication
(10) Pub. No.: US 2022/0314611 A1
(43) Pub. Date: Oct. 6, 2022

(54) PRINTING APPARATUS

(71) Applicant: Seiko Epson Corporation, Tokyo (JP)

(72) Inventor: Takuma HAYASHI, MATSUMOTO-SHI (JP)

(21) Appl. No.: 17/656,770

(22) Filed: Mar. 28, 2022

(30) Foreign Application Priority Data
Mar. 30, 2021 (JP) 2021-056782

(51) Int. Cl. B41J 2/045

(52) U.S. Cl. CPC B41J 2/04551; B41J 2/04586

(57) ABSTRACT

A printing apparatus includes: a printing head including a first nozzle row configured to eject ink, and a second nozzle row to eject ink of the same color; and a control unit configured to perform printing based on a selected printing mode; wherein D1>D2, where D1 is a difference between a usage ratio of the first nozzle row and a usage ratio of the second nozzle row when printing is performed in the first printing mode, and D2 is a difference between a usage ratio of the first nozzle row and a usage ratio of the second nozzle row when printing is performed in the second printing mode, and the control unit performs printing in the second printing mode when printing is performed under a printing condition that tends to make wind ripples noticeable when printing is performed in the first printing mode.

The present application is based on, and claims priority from JP Application Serial Number 2021-056782, filed Mar. 30, 2021, the disclosure of which is hereby incorporated by reference herein in its entirety.

### BACKGROUND

### 1. Technical Field

The present disclosure relates to a printing apparatus.

### 2. Related Art

A printing head of inkjet printers includes a nozzle row in which a plurality of nozzles are arranged. When ink is ejected simultaneously from each nozzle in the nozzle row, the air flow generated by each ejection affects one another. This can shift landing positions of the ejected ink on the printing medium. Such shift in landing positions causes density unevenness in printing results. The phenomenon in which density unevenness occurs in this manner and the resulting density unevenness is referred to as wind ripples.

To suppress the occurrence of wind ripples, a printing control apparatus is disclosed that controls ejection of fluid from a nozzle row in which a plurality of nozzles are arranged, and movement of the nozzle row in a direction intersecting a direction in which the nozzles are arranged. When an amount of the fluid to be ejected onto a continuous region in one movement of the nozzle row exceeds a predetermined threshold, the ejection of the fluid onto the continuous region is performed in a plurality of movements of the nozzle row (see JP-A-2015-150720).

According to JP-A-2015-150720, the occurrence of wind ripples can be suppressed by performing the ejection of the fluid onto the continuous region that is usually done in one movement of the nozzle row in a plurality of movements of the nozzle row. On the other hand, another problem arises that the printing speed decreases due to the increase in the number of movements. Accordingly, there is a need for further improvement to suppress the occurrence of wind ripples.

### SUMMARY

A printing apparatus includes: a printing head including a first nozzle row in which a plurality of nozzles configured to eject ink are arranged in a predetermined nozzle row direction, and a second nozzle row in which a plurality of nozzles configured to eject ink of the same color as that of the ink are arranged in the nozzle row direction, and a control unit configured to perform printing by selecting a printing mode in accordance with a printing condition, and controlling ink ejection onto a printing medium by the printing head based on the selected printing mode, wherein the printing mode includes a first printing mode and a second printing mode, wherein D1>D2, where D1 is a difference between a usage ratio of the plurality of nozzles of the first nozzle row and a usage ratio of the plurality of nozzles of the second nozzle row when printing is performed in the first printing mode, and D2 is a difference between a usage ratio of the plurality of nozzles of the first nozzle row and a usage ratio of the plurality of nozzles of the second nozzle row when printing is performed in the second printing mode, and wherein the control unit performs printing in the second printing mode when printing is performed under a printing condition that tends to make wind ripples noticeable when printing is performed in the first printing mode.

### BRIEF DESCRIPTION OF THE DRAWINGS

FIG. 1 is a block diagram illustrating an apparatus configuration in a simplified manner.

FIG. 2 is a view illustrating a relationship among a printing medium, a printing head, and the like as seen from a viewpoint above.

FIG. 3 is a view illustrating a relationship among a printing medium, a printing head, and the like as seen from a viewpoint facing the main scanning direction.

FIG. 4 is a flowchart illustrating printing control processing.

FIG. 5 is a flowchart illustrating an example of printing control processing different from that of FIG. 4.

FIG. 6A is a diagram illustrating an example of a relationship between first and second nozzle rows and image data in a first printing mode.

FIG. 6B is a diagram illustrating an example of a relationship between first and second nozzle rows and image data in a second printing mode.

FIG. 7 is a flowchart illustrating printing control processing according to a modified example.

### DESCRIPTION OF EXEMPLARY EMBODIMENTS

Hereinafter, embodiments of the present disclosure will be described with reference to the accompanying drawings. Note that each of the drawings is merely an example for illustrating the present embodiment. Since the drawings are examples, proportions and shapes may not be precise; the drawings may not match each other; and some portions may be omitted.

1. Apparatus Configuration

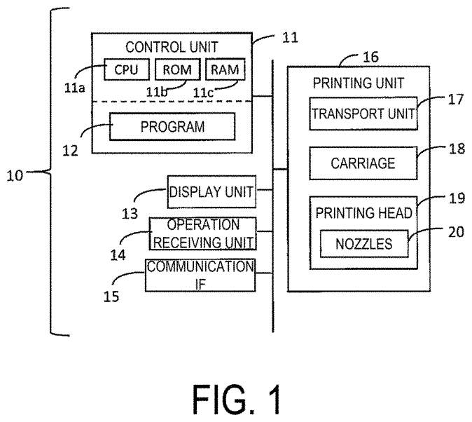

FIG. 1 illustrates a configuration of a printing apparatus 10 according to the present embodiment in a simplified manner.

The printing apparatus 10 includes a control unit 11, a display unit 13, an operation receiving unit 14, a communication IF 15, a printing unit 16, and the like. IF is an abbreviation for interface. The control unit 11 includes one or a plurality of integrated circuits (ICs) including a central processing unit (CPU) 11a, a read-only memory (ROM) 11b, a random access memory (RAM) 11c, and the like as a processor, another non-volatile memory, and the like.

In the control unit 11, the processor, that is, the CPU 11a performs arithmetic processing in accordance with one or more programs 12 stored in the ROM 11b or other components such as a memory using the RAM 11c or the like as a work area, thereby controlling the printing apparatus 10. Note that the processor is not limited to a single CPU. Processing may be performed by a plurality of CPUs or a hardware circuit such an application-specific integrated circuit (ASIC), and processing may be performed by a CPU and a hardware circuit working in concert.

The display unit 13 is a means for displaying visual information. The display unit 13 is constituted, for example, by a liquid crystal display, an organic electroluminescence (EL) display, or the like. The display unit 13 may include a display and a driving circuit for driving the display. The operation receiving unit 14 is a means for receiving an operation by a user. The operation receiving unit 14 is realized, for example, by a physical button, a touch panel, a mouse, a keyboard, or the like. Of course, the touch panel may be realized as a function of the display unit 13.

The display unit 13 and the operation receiving unit 14 may be part of the configuration of the printing apparatus 10, or may be peripheral devices externally coupled to the printing apparatus 10. The communication IF 15 is a generic term for one or a plurality of IFs for coupling the printing apparatus 10 with the outside in a wired or wireless manner compliant with a predetermined communication protocol including a known communication standard.

The printing unit 16 is a mechanism for performing printing on a printing medium by an inkjet method under the control of the control unit 11. The printing unit 16 includes a transport unit 17, a carriage 18, a printing head 19, and the like. The transport unit 17 is a means for transporting a printing medium such as a sheet in a predetermined transport direction. The transport unit 17 includes, for example, a roller, a motor for rotating the roller, and the like. The printing medium may be a medium made from a material other than paper as long as the medium is printable by liquid such as ink. Upstream and downstream in the transport direction are also simply referred to as upstream and downstream.

The printing head 19 includes a plurality of nozzles 20. The printing head 19 sometimes ejects and sometimes does not eject liquid such as ink from the nozzles 20 based on print data transported from the control unit 11 for printing an image, thereby printing the image on a printing medium. Ink droplets ejected by the nozzles 20 are called dots. The printing head 19 is configured to eject ink of various colors such as cyan (C), magenta (M), yellow (Y), and black (K), for example. Furthermore, in the present embodiment, pigment ink of K is denoted as “K1” or the “K1 ink”, while dye ink of K is denoted as “K2” or the “K2 ink”. Of course, the printing head 19 may also eject ink or liquid of a color other than C, M, Y, K1, and K2.

The carriage 18 is a mechanism capable of reciprocating along a predetermined main scanning direction as a result of receiving power from a carriage motor (not illustrated). The main scanning direction intersects the transport direction. To intersect herein may be understood as to be orthogonal or substantially orthogonal. The printing head 19 is mounted on the carriage 18. Therefore, the printing head 19 reciprocates along the main scanning direction together with the carriage 18.

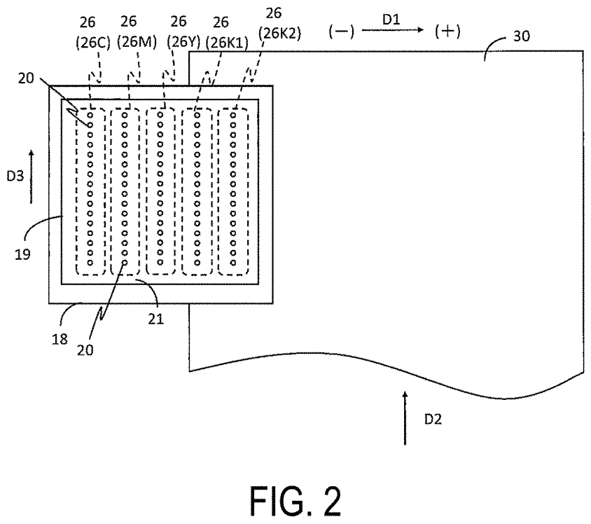

FIG. 2 illustrates a relationship between a printing medium 30 and the printing head 19 in a simplified manner as seen from a viewpoint above. The printing head 19 mounted on the carriage 18 performs, together with the carriage 18, forward movement from the minus end (−) to the plus end (+) of a main scanning direction D1, and backward movement from the plus end (+) to the minus end (−).

FIG. 2 illustrates an example of an arrangement of the nozzles 20 in a nozzle surface 21. The nozzle surface 21 is the lower surface of the printing head 19. Each small circle in the nozzle surface 21 is a nozzle 20. In a configuration in which ink of each color is supplied from a liquid holding means (not illustrated), which is called an ink cartridge, an ink tank, or the like, and ejected from the nozzles 20, the printing head 19 includes a nozzle row 26 for each ink type. FIG. 2 illustrates an example of the printing head 19 that ejects C, M, Y, K1, and K2 inks.

The nozzle row 26 including the nozzles 20 that eject the C ink is a nozzle row 26C. Similarly, the nozzle row 26 including the nozzles 20 that eject the M ink is a nozzle row 26M, and the nozzle row 26 including the nozzles 20 that eject the Y ink is a nozzle row 26Y. Similarly, the nozzle row 26 including the nozzles 20 that eject the K1 ink is a nozzle row 26K1, and the nozzle row 26 including the nozzles 20 that eject the K2 ink is a nozzle row 26K2. The nozzle rows 26C, 26M, 26Y, 26K1, and 26K2 are arranged along the main scanning direction D1. The nozzle row 26K1 and the nozzle row 26K2 correspond to specific examples of the “first nozzle row” and the “second nozzle row” configured to eject ink of the same color.

Each of the nozzle rows 26 is constituted by a plurality of nozzles 20 having a constant or substantially constant nozzle pitch, which is an interval between nozzles 20 in a transport direction D2. The direction in which a plurality of nozzles 20 constituting a nozzle row 26 are arranged is a nozzle row direction D3. In the example illustrated in FIG. 2, the nozzle row direction D3 is parallel with the transport direction D2. In a configuration in which the nozzle row direction D3 is parallel with the transport direction D2, the nozzle row direction D3 and the main scanning direction D1 are orthogonal to each other. However, the nozzle row direction D3 need not be parallel with the transport direction D2, and may diagonally intersect the main scanning direction D1. The plurality of nozzle rows 26 may be understood to be in the same position in the transport direction D2.

The operation in which the printing head 19 ejects ink in accordance with print data along with forward movement of the carriage 18 along the main scanning direction D1, or the operation in which the printing head 19 ejects ink in accordance with print data along with backward movement of the carriage 18 along the main scanning direction D1 is called a main scanning or a pass. The printing unit 16 performs printing on the printing medium 30 by repeating passes and transport of the printing medium 30 in the transport direction D2 by a constant amount by the transport unit 17 (hereinafter, paper feed).

The configuration of the printing apparatus 10 illustrated in FIG. 1 may be realized by a single printer, or may be realized by a plurality of apparatuses communicatively coupled to each other.

In other words, the printing apparatus 10 may be a printing system 10 in actuality. The printing system 10 includes, for example, a printing control apparatus that functions as the control unit 11, and a printer corresponding to the printing unit 16 controlled by the printing control apparatus.

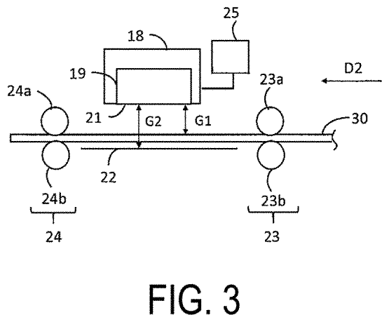

FIG. 3 illustrates a relationship between the printing medium 30 and the printing head 19 in a simplified manner as seen from a viewpoint facing the main scanning direction D1. The nozzle surface 21 of the printing head 19 mounted on the carriage 18 is opposed to a platen 22. The platen 22 is a surface that supports the printing medium 30 that is transported at a position below the printing head 19. Furthermore, the platen 22 constitutes part of a transport path for the printing medium 30. The distance between the printing head 19 and the printing medium 30 supported by the platen 22 in the vertical direction is denoted as the first gap G1. Furthermore, the distance between the printing head 19 and the platen 22 in the vertical direction is denoted as the second gap G2. The control unit 11 can recognize a value obtained by subtracting the thickness of the printing medium 30 placed in the printing unit 16 from the second gap G2 as the first gap G1. The thickness of the printing medium 30 can be identified from information about the type or the like of the printing medium 30, which is set by the user through the operation accepting unit 14 or the like.

A first transport roller pair 23 is disposed upstream of the printing head 19. The first transport roller pair 23 is a pair of rollers 23a and 23b. The first transport roller pair 23 rotates while sandwiching the printing medium 30 by the rollers 23a and 23b, thereby transporting the printing medium 30 in the transport direction D2. One of the rollers 23a and 23b constituting the pair is driven by a motor (not illustrated), while the other is rotated as a driven roller. Furthermore, a second transport roller pair 24 is disposed downstream of the printing head 19. The second transport roller pair 24 is a pair of rollers 24a and 24b. The second transport roller pair 24 rotates while sandwiching the printing medium 30 by the rollers 24a and 24b, thereby transporting the printing medium 30 in the transport direction D2. One of the rollers 24a and 24b constituting the pair is driven by the same motor (not illustrated) as that for the first transport roller pair 23, while the other is rotated as a driven roller. The transport roller pairs 23 and 24 each constitute part of the transport unit 17.

FIG. 3 illustrates an elevator 25 included in the printing unit 16 in a very simple manner. The elevator 25 includes a mechanism such as a motor for moving the carriage 18 in the vertical direction. The elevator 25 can adjust the second gap G2, which is employed during printing, by moving the carriage 18 up and down in accordance with an instruction from the user. Adjusting the second gap G2 consequently adjusts the first gap G1 as well.

2. Printing Control Processing

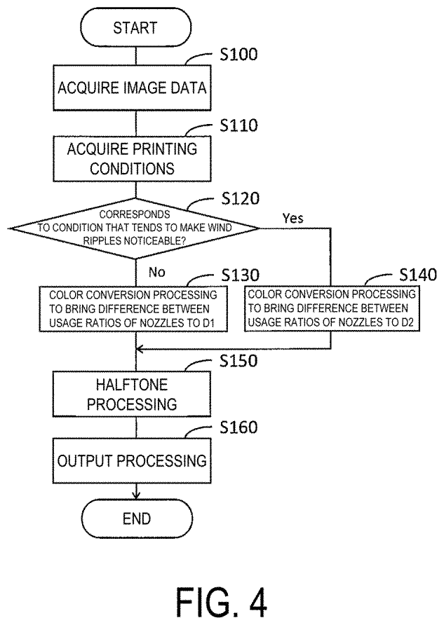

FIG. 4 illustrates printing control processing performed by the control unit 11 in accordance with the program 12 in a flowchart.

The control unit 11 starts printing control processing in response to a printing instruction by the user through the operation accepting unit 14 or the like. In step S100, the control unit 11 acquires image data representing an image to be printed from a predetermined storage source, such as an accessible memory, in accordance with the printing instruction.

Image data is an image file generated in a predetermined format at the time of acquisition. The control unit 11 converts the image file into RGB data in a bitmap format having gradation values of red (R), green (g), and blue (b) for each pixel. If the image file is RGB data at the time of acquisition, such conversion is unnecessary. In RGB data, each of R, G, and B in each pixel is expressed, for example, in 256 gradations of 0 to 255.

In step S110, the control unit 11 acquires current printing conditions. Printing conditions may be already set through operation of the operation accepting unit 14 or the like by the user, or included in the printing instruction. The printing conditions include information such as, for example, a first gap G1, a second gap G2, the type of the printing medium, and a carriage speed. Furthermore, the content and type of the image represented by the image data may also be considered as a kind of printing condition.

In step S120, the control unit 11 determines whether the printing conditions acquired in step S110 correspond to a predetermined condition that tends to make “wind ripples” noticeable in the printing result. Here, wind ripples refer to wind ripples-like density unevenness caused on the printing result when dots ejected from the nozzles 20 are affected by air flow before landing on the printing medium 30, which causes dots to land in positions shifted from ideal landing positions in some portions of the printing medium 30, and causes a decrease in ink coverage ratio in such portions. Alternatively, density unevenness that occurs in this manner is called wind ripples.

In the present embodiment, the control unit 11 perform printing by selecting a printing mode in accordance with the printing conditions, and controlling ink ejection onto the printing medium 30 by the printing head 19 based on the selected printing mode. The printing apparatus 10 includes at least a “first printing mode” and a “second printing mode” as printing modes. The second printing mode is a printing mode that makes wind ripples less noticeable than the first printing mode. Therefore, printing conditions that tend to make wind ripples noticeable can be said more precisely to be printing conditions that tend to make wind ripples noticeable when printing is performed in the first printing mode.

A specific example of a method of determining whether a condition tends to make wind ripples noticeable in step S120 will be described later. When it is determined that the printing conditions do not correspond to a predetermined condition that tends to make wind ripples noticeable, the control unit 11 proceeds from “No” in step S120 to step S130. On the other hand, when it is determined that the printing conditions correspond to a printing condition that tends to make wind ripples noticeable, the control unit 11 proceeds from “Yes” in step S120 to step S140.

In step S130, the control unit 11 performs color conversion processing to bring the difference between the usage ratio of the nozzles 20 of the first nozzle row and the usage ratio of the nozzles 20 of the second nozzle row to D1. Note that the usage ratio of the nozzles 20 in the nozzle row 26 refers to the proportion of nozzles 20 to which print data is allocated among usable nozzles 20 in the nozzle row 26. If all of the nozzles 20 of one nozzle row 26 are usable nozzles 20, and print data is allocated to half of these usable nozzles 20, then the usage ratio of the nozzles 20 of that nozzle row 26 is 50%.

Here, the nozzle row 26K1 is a first nozzle row, and the nozzle row 26K2 is a second nozzle row. The color conversion processing is processing that convert image data as RGB data into CMYK data in a bitmap format having gradation values of C, M, Y, and K for each pixel. It is only required that the control unit 11 performs color conversion processing with reference to a color conversion look-up table (hereinafter, a color conversion LUT) that is stored in advance in a predetermined memory or the like and that defines a conversion relationship from RGB to CMYK.

The color conversion LUT referred to in step S130 is a LUT designed to output, as a conversion result for input RGB, only a gradation value of K1 as a gradation value of K. Therefore, in step S130, each of the pixels of the image data is converted from RGB to CMYK1, with the converted image data including no gradation value of K2 in all of the pixels. According to step S130 described above, when an image is printed based on the print data that has been subjected to halftone processing to be described later, all of K to be printed in the image is printed with the K1 ink by the nozzles 20 of the nozzle row 26K1, without the nozzles 20 of the nozzle row 26K2 being used. Therefore, according to step S130, the usage ratio of the nozzles 20 of the nozzle row 26K1 is 100%, and the usage ratio of the nozzles 20 of the nozzle row 26K2 is 0%, hence D1=100%−0%=100%. Proceeding from the determination of step S120 to step S130 consequently corresponds to selecting the “first printing mode” and performing printing in the first printing mode.

On the other hand, in step S140, the control unit 11 performs color conversion processing to bring the difference between the usage ratio of the nozzles 20 of the first nozzle row and the usage ratio of the nozzles 20 of the second nozzle row to D2. The control unit 11 performs control so as to satisfy D1>D2. In step S140, for example, with reference to the same color conversion LUT as that of step S130, the control unit 11 converts each of the pixels of the image data from RGB to CMYK1, and replaces a gradation value of K1 with a gradation value of K2 at one pixel out of every two pixels in the transport direction D2. As a result, half of the pixels constituting the image data have gradation values of C, M, Y, and K1 but no gradation value of K2, while the remaining pixels have gradation values of C, M, Y, and K2 but no gradation value of K1. Note that the replacement of a gradation value of K1 with a gradation value of K2 may be performed such that the size of the gradation value is maintained as is, or may be performed such that, for example, the gradation value after replacement is greater by a predetermined amount, considering the difference in density between pigment ink and dye ink taken.

According to step S140 described above, when an image is printed based on the print data that has been subjected to halftone processing to be described later, K to be printed in the image is printed by the nozzles 20 of the nozzle row 26K1 and the nozzles 20 of the nozzle row 26K2, with the nozzles 20 of the nozzle row 26K1 sharing approximately half of the amount and the nozzles 20 of the nozzle row 26K2 sharing approximately half of the amount. Therefore, according to step S140, the usage ratio of the nozzles 20 of the nozzle row 26K1 is 50%, and the usage ratio of the nozzles 20 of the nozzle row 26K2 is 50%, hence D2=50%-50%=0%. Proceeding from the determination of step S120 to step S140 consequently corresponds to selecting the “second printing mode” and performing printing in the second printing mode.

After step S130 or step S140, in step S150, the control unit 11 performs halftone processing on the image data obtained by the color conversion processing in step S130 or step S140. According to halftone processing, the image data after color conversion is converted to image data defining ejection of the corresponding ink (dot-on) or non-ejection of the ink (dot-off) for each pixel and for each of C, M, Y, K1, and K2. Halftone processing can be performed using, for example, a dithering method or an error diffusion method. Of course, no dot-on of the K1 ink is defined for pixels having no gradation value of K1. Similarly, no dot-on of the K2 ink is defined for pixels having no gradation value of K2.

In step S160, the control unit 11 outputs the image data after halftone processing as print data to the printing unit 16 to cause the printing unit 16 to perform printing based on the print data. In this case, the control unit 11 allocates and outputs the data of the pixels of the print data to the nozzles 20 of the nozzle rows 26 of the printing head 19 in accordance with the ink type, the position within the image, and the printing order. The printing unit 16 that received the output of the print data repeats passes by the carriage 18 and the printing head 19, and paper feeding by the transport unit 17, thereby causing the image represented by the print data to be printed on the printing medium 30. According to the flowchart described above, printing performed by the printing unit 16 after step S130 in step S160 is printing in the first printing mode, and printing performed by the printing unit 16 in step S160 after step S140 is printing in the second printing mode.

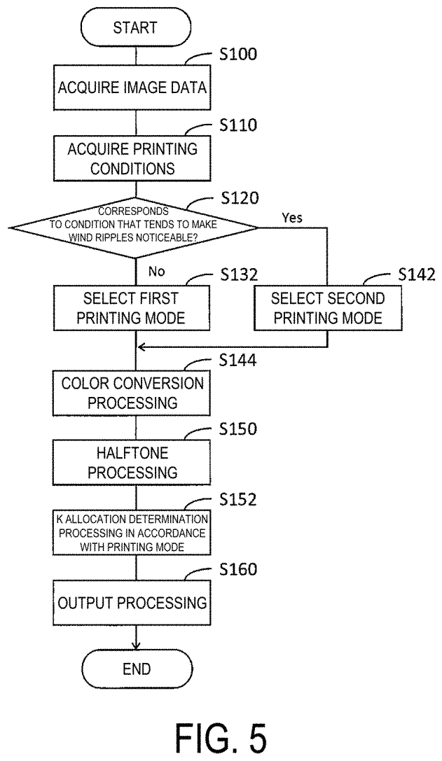

FIG. 5 illustrates printing control processing performed by the control unit 11 in accordance with the program 12, and illustrates an example different from that illustrated in FIG. 4 in a flowchart. The control unit 11 may perform FIG. 5 instead of FIG. 4. For FIG. 5, differences from FIG. 4 will be described, with description of the matters common to FIG. 4 being omitted.

In step S120, when it is determined that the printing conditions do not correspond to a predetermined condition that tends to make wind ripples noticeable, the control unit 11 proceeds from “No” to step S132, and when it is determined that the printing conditions correspond to a predetermined condition that tends to make wind ripples noticeable, the control unit 11 proceeds from “Yes” to step S142.

In step S132, the control unit 11 selects the first printing mode as the printing mode. On the other hand, in step S142, the control unit 11 selects the second printing mode as the printing mode.

After step S132 or step S142, in step S144, the control unit 11 performs color conversion processing of the image data. In step S144, it is only required that the control unit 11 converts the image data as RGB data into CMYK data in a bitmap format having gradation values of C, M, Y, and K for each pixel.

After steps S144 and S150, in step S152, the control unit 11 determines the nozzle 20 to which K data is allocated in accordance with the printing mode. In other words, if the first printing mode has been selected, the control unit 11 determines to allocate K data in all of the pixels of the image data after halftone processing to the nozzles 20 of the nozzle row 26K1. According to this determination, when an image is printed based on the print data, all of K to be printed in the image is printed with the K1 ink by the nozzles 20 of the nozzle row 26K1, without the nozzles 20 of the nozzle row 26K2 being used. Therefore, the usage ratio of the nozzles 20 of the nozzle row 26K1 is 100%, and the usage ratio of the nozzles 20 of the nozzle row 26K2 is 0%, hence D1=100%.

On the other hand, if the second printing mode has been selected, in step S152, the control unit 11 determines to allocate K data in half of the pixels of the image data after halftone processing to the nozzles 20 of the nozzle row 26K1, and allocate K data in the remaining pixels of the pixels to the nozzles 20 of the nozzle row 26K2. According to this determination, when an image is printed based on the print data, K to be printed in the image is printed by the nozzles 20 of the nozzle row 26K1 and the nozzles 20 of the nozzle row 26K2, with the nozzles 20 of the nozzle row 26K1 sharing approximately half of the amount and the nozzles 20 of the nozzle row 26K2 sharing approximately half of the amount. Therefore, the usage ratio of the nozzles 20 of the nozzle row 26K1 is 50%, and the usage ratio of the nozzles 20 of the nozzle row 26K2 is 50%, hence D2=0%.

After step S152, in step S160, as described above, when outputting the image data after halftone processing as print data to the printing unit 16, the control unit 11 allocates and outputs the data of the pixels to the nozzles 20 of the nozzle rows 26 of the printing head 19 in accordance with the ink type, the position within the image, and the printing order. At this time, the control unit 11 allocates and outputs K data in the pixels to the nozzles 20 of the nozzle rows 26K1 and 26K2 in accordance with the determination in step S152. According to the flowchart of FIG. 5 described above, printing performed after step S132 in step S160 by the printing unit 16 consequently corresponds to printing in the first printing mode, and printing performed after step S142 in step S160 by the printing unit 16 consequently corresponds to printing in the second printing mode.

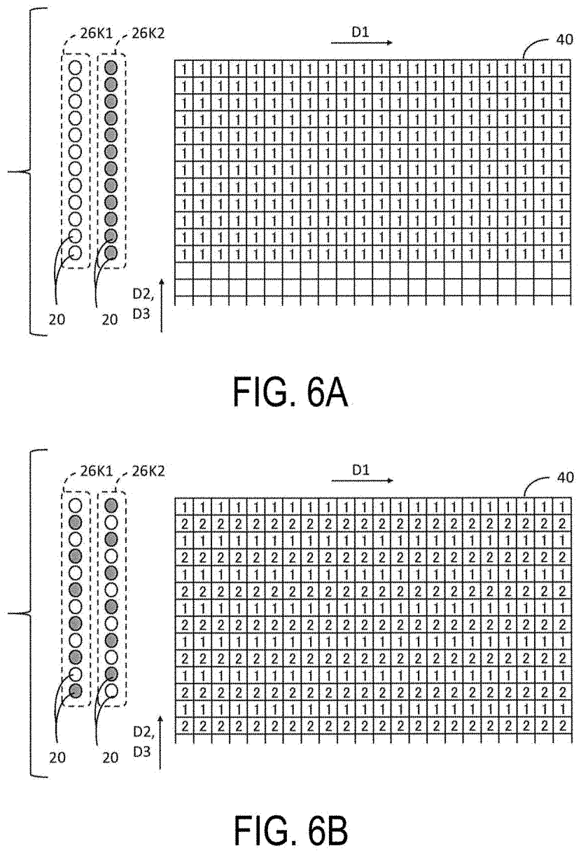

FIG. 6A illustrates an example of an allocation relationship between the first nozzle row and the second nozzle row, and the image data in the first printing mode. In the description of FIGS. 6A and 6B, K1 and K2 are sometimes collectively referred to as K. FIG. 6A illustrates the nozzle row 26K1 and the nozzle row 26K2 of the nozzle rows 26 included in the printing head 19. Furthermore, image data 40 is the image data after halftone processing in step 150, and is data corresponding to K. Each rectangle constituting the image data 40 is a pixel. FIG. 6A also illustrates a correspondence relationship between nozzle rows 26, the image data 40, and the directions D1, D2, and D3.

In FIG. 6A, of the nozzles 20 constituting the nozzle rows 26K1 and 26K2, nozzles 20 (used nozzles) to which K data is allocated are indicated with a white circle, and nozzles 20 (unused nozzles) to which K data is not allocated are indicated with a gray circle. According to FIG. 6A, all of the nozzles 20 in the nozzle row 26K1 are used nozzles, and all of the nozzles 20 of the nozzle row 26K2 are unused nozzles. Furthermore, the number written in each of the pixels of the image data 40 means whether the nozzle row 26 to which the data will be allocated at the time of printing is the nozzle row 26K1 or 26K2, with “1” meaning the nozzle row 26K1 and “2” meaning the nozzle row 26K2.

In FIG. 6A, the numbers written in the pixels of the image data 40 are all “1”. Note that in FIG. 6A, of the image data 40, for the pixels within a region to be subjected to printing in one pass of the printing head 19, numbers indicating the nozzle row 26K1 or 26K2 to which the data will be allocated are written. Of course, for all of the pixels in the image data 40, the nozzle row to which the data will be allocated is determined in the same manner. According to FIG. 6A described above, in the first printing mode, if all of the pixels of the image data 40 are defined as dot-on of the K ink, the dots of the K ink in all of the pixels are printed with the K1 ink by the nozzles 20 of the nozzle row 26K1. In other words, the usage ratio of the nozzles 20 of the nozzle row 26K1 is 100%, and the usage ratio of the nozzle row 26K2 is 0%.

FIG. 6B illustrates an example of a relationship between the first nozzle row and the second nozzle row, and the image data in the second printing mode. How to view FIG. 6B is the same as how to view FIG. 6A. According to FIG. 6B, the nozzles 20 of the nozzle row 26K1 alternately correspond to used nozzles and unused nozzles along the nozzle row direction D3. Furthermore, according to FIG. 6B, the nozzles 20 of the nozzle row 26K2 alternately correspond to unused nozzles and used nozzles along the nozzle row direction D3. When viewed at the same position in the transport direction D2, one of the nozzles 20 of the nozzle rows 26K1 and 26K2 is a used nozzle, and the other nozzle 20 is an unused nozzle.

Furthermore, in FIG. 6B, the image data 40 is alternately associated with “1” and “2” in raster line units. A raster line is a row formed by pixels arranged along the main scanning direction D1. In other words, in step S140 of FIG. 4, the control unit 11 alternately gives K1 gradation values and K2 gradation values in such raster line units. Furthermore, in FIG. 5, after S142 in step S152, the control unit 11 alternately allocates the nozzles 20 of the nozzle row 26K1 and the nozzles 20 of the nozzle row 26K2 in such raster line units. According to FIG. 6B described above, in the second printing mode, if all of the pixels of the image data 40 are defined as dot-on of the K ink, the dots of the K ink in all of the pixels are alternately printed with the K1 ink and the K2 ink in raster line units. In other words, the usage ratio of the nozzles 20 of the nozzle row 26K1 is 50%, and the usage ratio of the nozzles 20 of the nozzle row 26K2 is 50%.

3. Determination of Printing Conditions

Several specific examples of the determination method of step S120 will be described.

### First Example

When the first gap G1 is wide, the flight time of dots from being ejected from nozzles 20 until landing on the printing medium 30 is long. This causes a larger shift in landing positions of dots and tends to make wind ripples noticeable. Accordingly, in step S120, the control unit 11 determines whether the first gap G1 included in the printing conditions acquired in step S110 is greater than or equal to a predetermined threshold for the first gap G1 (hereinafter, the first gap threshold).

Note that the control unit 11 may calculate the first gap G1 from any other information obtained as a printing condition. As described above, if the printing unit 16 includes the elevator 25, the current second gap G2 adjusted by the elevator 25 is included in the printing conditions. If the printing unit 16 does not include the elevator 25, the second gap G2 as a fixed value is included in the printing conditions. It is only required that the control unit 11 recognizes, as the first gap G1, a value obtained by subtracting the thickness of the printing medium 30, which can be found from the type of the printing medium 30 included in the printing conditions, from the second gap G2 described above.

Then, if the first gap G1 is greater than or equal to the first gap threshold, on the ground that it corresponds to a printing condition that tends to make wind ripples noticeable, the control unit 11 determines “Yes” in step S120. On the other hand, if the first gap G1 is less than the first gap threshold, since it does not correspond to a printing condition that tends to make wind ripples noticeable, the control unit 11 determines “No” in step S120.

### Second Example

When the second gap G2 is wide, the first gap G1 may be determined to be wide as well in a simplified manner. In other words, in step S120, the control unit 11 may determine whether the second gap G2 included in the printing conditions acquired in step S110 is greater than or equal to a predetermined threshold for the second gap G2 (hereinafter, the second gap threshold). Note that the second gap threshold is greater than the first gap threshold. Then, if the second gap G2 is greater than or equal to the second gap threshold, on the ground that it corresponds to a printing condition that tends to make wind ripples noticeable, the control unit 11 determines “Yes” in step S120. On the other hand, if the second gap G2 is less than the second gap threshold, since it does not correspond to a printing condition that tends to make wind ripples noticeable, the control unit 11 determines “No” in step S120.

### Third Example

The faster the carriage speed, which is the movement speed of the carriage 18 when a pass is performed, the more strongly dots ejected from nozzles 20 are affected by the impact of air flow. This causes a larger shift in landing position of dots and tends to make wind ripples noticeable. Furthermore, to achieve a predetermined print resolution in the main scanning direction D1 in a single pass, the printing head 19 also needs to increase the driving frequency of the nozzles 20, which is the number of times that the nozzles 20 are driven per unit time when the carriage speed is increased. In other words, the carriage speed and the driving frequency of the nozzles 20 are in a proportional relationship.

Thus, in step S120, the control unit 11 may determine whether the driving frequency of the nozzles 20 in the printing head 19 is greater than or equal to a predetermined threshold for the driving frequency (hereinafter, the frequency threshold). The control unit 11 can derive the driving frequency of the nozzles 20 from the carriage speed included in the printing conditions acquired in step S110 using a predetermined correspondence relationship table or calculation formula. Alternatively, the printing conditions acquired in step S110 may include information about the driving frequency of the nozzles 20.

Then, if the driving frequency of the nozzles 20 is greater than or equal to the frequency threshold, on the ground that it corresponds to a printing condition that tends to make wind ripples noticeable, the control unit 11 determines “Yes” in step S120. On the other hand, if the driving frequency of the nozzles 20 is less than the frequency threshold, since it does not correspond to a printing condition that tends to make wind ripples noticeable, the control unit 11 determines “No” in step S120. Alternatively, the control unit 11 may regard the carriage speed itself included in the printing conditions acquired in step S110 as the driving frequency of the nozzles 20, and compare the carriage speed to a predetermined threshold to perform determination in the same manner.

### Fourth Example

The susceptibility or resistance to ink bleed-through of the printing medium 30 also affects the noticeability of wind ripples. In other words, if the printing medium 30 is susceptible to ink bleed-through, landed dots easily spread out, which prevents the ink coverage ratio from decreasing due to shift in landing positions and makes wind ripples unnoticeable. Conversely, if the printing medium 30 is resistant to ink bleed-through, landed dots do not spread out much, which is weak in preventing the ink coverage ratio from decreasing due to shift in landing positions and tends to make wind ripples noticeable.

Thus, when the type of the printing medium 30 included in the printing conditions acquired in step S110 corresponds to the first printing medium, on the ground that it does not correspond to a printing condition that tends to make wind ripples noticeable, the control unit 11 may determine “No” in step S120. When the type of the printing medium 30 corresponds to the second printing medium, on the ground that it corresponds to a printing condition that tends to make wind ripples noticeable, the control unit 11 may determine “Yes” in step S120. Note that the first printing medium refers to a group of printing media predefined as a type having a property of being relatively susceptible to ink bleed-through, and the second printing medium refers to a group of printing media predefined as a type having a property of being more resistant to ink bleed-through than the first printing medium.

### Fifth Example

The proportion of the ink amount of the color to be ejected by the first nozzle row and the second nozzle row to the total amount of ink to be ejected based on the image data, that is, the print data, also affects the noticeability of wind ripples. In other words, the greater the ejection proportion of the K ink, which is the color of interest, the greater the ejection amount per unit time. This causes dots to be more strongly affected by the impact of air flow, causes a larger shift in landing position of dots, and tends to make wind ripples noticeable.

Thus, in step S120, based on the image data acquired in step S100, the control unit 11 may determine whether the proportion of the ink amount of K to the total amount of ink to be ejected is greater than or equal to a predetermined threshold for the ink amount (hereinafter, the proportion threshold). Note that at the stage of step S120, the image data is RGB data, so the control unit 11 predicts or calculates from the image data the proportion of the ink amount of K to the total amount of ink of C, M, Y, and K to be ejected. For example, it is only required that the control unit 11 regards the proportion of the number of black pixels to the total pixel count of the image data as the proportion of the ink amount of K, and compares this proportion of the ink amount of K to the proportion threshold. Black pixels are pixels where R=G=B=0 in RGB data.

The proportion of the ink amount of K to the total amount of ink to be ejected can also be said to be the proportion of black area to the area of the image represented by the image data. Furthermore, if monochrome printing using only the K ink is indicated in the printing conditions acquired in step S110, it is only required that the control unit 11 determines that the proportion of the ink amount of K to the total amount of ink to be ejected is greater than or equal to the proportion threshold.

Then, if the proportion of the ink amount of the color to be ejected by the first nozzle row and the second nozzle row to the total amount of ink to be ejected is greater than or equal to the proportion threshold, on the ground that it corresponds to a printing condition that tends to make wind ripples noticeable, the control unit 11 determines “Yes” in step S120. On the other hand, if the proportion of the ink amount of the color to be ejected by the first nozzle row and the second nozzle row to the total amount of ink to be ejected is less than the proportion threshold, since it does not correspond to a printing condition that tends to make wind ripples noticeable, the control unit 11 determines “No” in step S120.

In step S120, the control unit 11 may perform determination employing any one of the first to fifth examples described above.

However, in step S120, the control unit 11 may perform each of the determinations of the first to fifth examples and, when it is determined in at least one determination that the printing condition corresponds to a printing condition that tends to make wind ripples noticeable, select “Yes”. In this case, the control unit 11 performs each of the determinations of the first to fifth examples and, when it is determined in all of the determinations that the printing condition does not correspond to a printing condition that tends to make wind ripples noticeable, selects “No” in step S120.

4. Summary

As described above, according to the present embodiment, the printing apparatus 10 includes the printing head 19 including a first nozzle row in which a plurality of nozzles 20 configured to eject ink are arranged in the predetermined nozzle row direction D3, and a second nozzle row in which a plurality of nozzles 20 configured to eject ink of the same color as that of the ink are arranged in the nozzle row direction D3; and the control unit 11 configured to perform printing by selecting a printing mode in accordance with a printing condition, and controlling ink ejection onto the printing medium 30 by the printing head 19 based on the selected printing mode. The printing apparatus 10 includes a first printing mode and a second printing mode as printing modes. D1>D2, where D1 is a difference between a usage ratio of the plurality of nozzles 20 of the first nozzle row and a usage ratio of the plurality of nozzles 20 of the second nozzle row when printing is performed in the first printing mode, and D2 is a difference between a usage ratio of the plurality of nozzles 20 of the first nozzle row and a usage ratio of the plurality of nozzles 20 of the second nozzle row when printing is performed in the second printing mode. The control unit 11 performs printing in the second printing mode when printing is performed under a printing condition that tends to make wind ripples noticeable when printing is performed in the first printing mode.

To put it differently, the control unit 11 controls ink ejection so as to satisfy D1>D2, and in the case of a printing condition that tends to make wind ripples more noticeable than a printing condition under which printing is performed in the first printing mode, performs printing in the second printing mode.

According to the configuration described above, in the first printing mode, the control unit 11 performs printing using one of the first nozzle row and the second nozzle row configured to eject ink of the same color more than the other. In the second printing mode, a difference between the usage ratio of the nozzles 20 of the first nozzle row and the usage ratio of the nozzles 20 of the second nozzle row is reduced compared to that in the first printing mode. Therefore, in the case of a printing condition that tends to make wind ripples noticeable, performing printing in the second printing mode makes it possible to precisely suppress the occurrence of wind ripples due to the impact of air flow, as wind ripples due to the impact of air flow become prominent when many nozzles 20 in one nozzle row 26 are simultaneously used. Furthermore, adopting a configuration including a first nozzle row and a second nozzle row configured to eject ink of the same color makes it possible to share printing of the same color among a plurality of nozzle rows 26 without increasing the number of passes, and suppress the occurrence of wind ripples.

As described above, D1=100% and D2=0% are merely examples. It is only required that the control unit 11 sets the usage ratios of the nozzles 20 of the first nozzle row and the nozzles 20 of the second nozzle row as long as such usage ratios satisfy D1>D2. For example, in the first printing mode, the control unit 11 may set the usage ratio of the nozzles 20 of the first nozzle row to 90%, and the usage ratio of the nozzles 20 of the second nozzle row to 10%, hence D1=90%-10%=80%. In the second printing mode, the control unit 11 may set the usage ratio of the nozzles 20 of the first nozzle row to 60%, and the usage ratio of the nozzles 20 of the second nozzle row to 40%, hence D2=60%-40%=20%.

Furthermore, according to the present embodiment, the nozzles 20 of the first nozzle row eject pigment ink, and the nozzles 20 of the second nozzle row eject dye ink of the same color as that of the pigment ink.

According to this configuration, for example, in the first printing mode, only the pigment ink can be used for a certain color or the pigment ink can be used more than the dye ink so that a high density printing result can be obtained for the color. In the second printing mode, the pigment ink and the dye ink can be used to the same degree to precisely suppress wind ripples.

However, the relationship between the first nozzle row and the second nozzle row assumed in the present embodiment is not limited to the relationship between the nozzle row 26K1 that ejects pigment ink and the nozzle row 26K2 that ejects dye ink. For example, two nozzle rows 26 that each ejects pigment ink of K may be used as the first nozzle row and the second nozzle row. Conversely, two nozzle rows 26 that each ejects dye ink of K may be used as the first nozzle row and the second nozzle row.

Furthermore, according to the present embodiment, when the printing condition is a printing condition in which the first gap G1, which is a distance between the printing head 19 and the printing medium 30, is greater than or equal to a predetermined threshold for the first gap G1, the control unit may perform printing in the second printing mode.

According to this configuration, in a situation that tends to make wind ripples noticeable because the first gap G1 is relatively wide, it is possible to suppress the occurrence of wind ripples.

Furthermore, according to the present embodiment, the printing apparatus 10 may include the platen 22 that supports the printing medium 30, and the control unit 11 may perform printing in the second printing mode when the printing condition is a printing condition in which the second gap G2, which is a distance between the printing head 19 and the platen 22, is greater than or equal to a predetermined threshold for the second gap G2.

According to this configuration, in a situation that tends to make wind ripples noticeable because the second gap G2 is relatively wide, it is possible to suppress the occurrence of wind ripples.

Furthermore, according to the present embodiment, the control unit 11 may perform printing in the second printing mode when the printing condition is a printing condition in which the driving frequency of the nozzles 20 in the printing head 19 is greater than or equal to a predetermined threshold for the driving frequency.

According to this configuration, in a situation that tends to make wind ripples noticeable because the driving frequency of the nozzles 20 is relatively high, it is possible to suppress the occurrence of wind ripples.

Furthermore, according to the present embodiment, the control unit 11 may perform printing in the first printing mode when the first printing medium is used as the printing medium 30, and may perform printing in the second printing mode when the printing condition is a printing condition in which the second printing medium having a property of being more resistant to ink bleed-through than the first printing medium is used as the printing medium 30.

According to this configuration, in a situation that tends to make wind ripples noticeable because the second printing medium resistant to ink bleed-through is used, it is possible to suppress the occurrence of wind ripples.

Furthermore, according to the present embodiment, the control unit 11 may perform printing based on image data, and perform printing in the second printing mode when the printing condition is a printing condition in which the proportion of the amount of the ink of the same color to the total amount of ink to be ejected based on the image data is greater than or equal to a predetermined threshold for the ink amount.

According to this configuration, in a situation that tends to make wind ripples noticeable because the ejection amount per unit time is increased, it is possible to suppress the occurrence of wind ripples.

Furthermore, according to the present embodiment, the nozzles 20 of the first nozzle row and the nozzles 20 of the second nozzle row eject black ink.

According to this configuration, it is possible to precisely suppress the occurrence of wind ripples by performing the second printing mode for K, which is a color that tends to make wind ripples noticeable.

However, the color of ink ejected by both the first nozzle row and the second nozzle row is not limited to K, and may be other colors such as C, M, and Y. A configuration may be adopted that includes a first nozzle row and a second nozzle row for each of C, M, Y, and K.

### 5. Modified Examples

There may be more than two printing modes that can be selected depending on the degree of noticeability of wind ripples.

For example, the printing apparatus 10 further includes a third printing mode as a printing mode. The control unit controls ink ejection so as to satisfy D1>D3>D2, where D3 is the difference between the usage ratio of the nozzles 20 of the first nozzle row and the usage ratio of the nozzles 20 of the second nozzle row when printing is performed in the third printing mode. Then, in the case of a printing condition that tends to make wind ripples more noticeable than a printing condition under which printing is performed in the first printing mode, and that tends to make wind ripples less noticeable than a printing condition under which printing is performed in the second printing mode, the control unit may perform printing in the third printing mode.

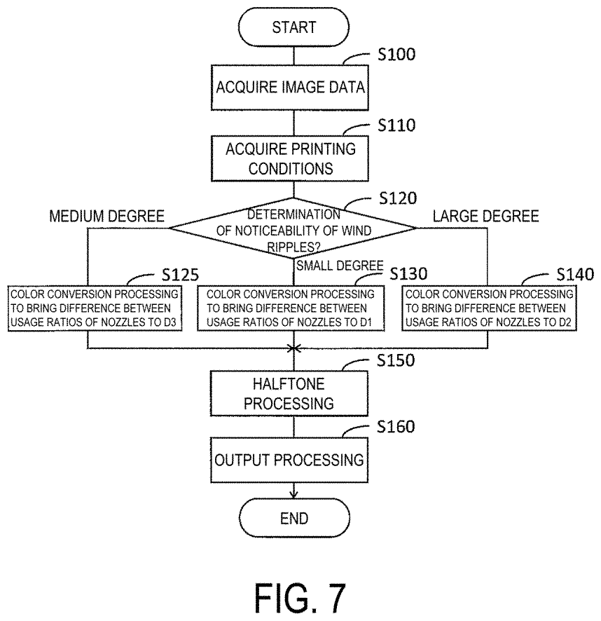

FIG. 7 illustrates printing control processing according to such a modified example in a flowchart. Generally, FIG. 7 differs from FIG. 4 in that FIG. 7 includes step S125 as a branch destination from step S120. In step S120 of FIG. 7, the control unit 11 determines the degree of noticeability of wind ripples based on the printing conditions acquired in step S110. Here, whether the degree of noticeability of wind ripples is “Small degree”, “Medium degree”, or “Large degree” is determined. “Small degree” corresponds to “No” in step S120 in FIGS. 4 and 5 described previously, and “Large degree” corresponds to “Yes” in step S120 in FIGS. 4 and 5 described previously.

In step S120 of FIG. 7, a case is envisioned in which the first example is applied. In this case, the control unit 11 sets in advance two first gap thresholds having different values to which the first gap G1 is to be compared. Then, if the first gap G1 is greater than or equal to the larger first gap threshold, on the ground that it corresponds to “Large degree”, the control unit 11 proceeds to step S140. Furthermore, if the first gap G1 is less than the larger first gap threshold and greater than or equal to the smaller first gap threshold, on the ground that it corresponds to “Medium degree”, the control unit 11 proceeds to step S125. Furthermore, if the first gap G1 is less than the smaller first gap threshold, on the ground that it corresponds to “Small degree”, the control unit 11 proceeds to step S130.

In step S120 of FIG. 7, even when any of the second to fifth examples is applied, it is only required that the control unit 11 determines which of “Small degree”, “Medium degree”, and “Large degree” is applicable by comparing the second gap G2, the driving frequency, or the proportion of the amount of the ink of the same color to the total amount of ink to be ejected based on the image data to a plurality of thresholds, or determines which of “Small degree”, “Medium degree”, and “Large degree” is applicable to the type of the printing medium 30 in terms of susceptibility to ink bleed-through.

To follow previous examples, in the description of step S125, it is assumed that the usage ratio of the nozzles 20 of the nozzle row 26K1 in the first printing mode is 100%, and the usage ratio of the nozzles 20 of the nozzle row 26K2 is 0%, hence D1=100%. Furthermore, it is assumed that in the second printing mode, the usage ratio of the nozzles 20 of the nozzle row 26K1 is 50%, and the usage ratio of the nozzles 20 of the nozzle row 26K2 is 50%, hence D2=0%. In step S125, the control unit 11 performs color conversion processing to bring the difference between the usage ratio of the nozzles 20 of the first nozzle row and the usage ratio of the nozzles 20 of the second nozzle row to D3. The control unit 11 performs control so as to satisfy D1>D3>D2.

In step S125, for example, with reference to the same color conversion LUT as that of step S130, the control unit 11 converts each of the pixels of the image data from RGB to CMYK1, and replaces a gradation value of K1 with a gradation value of K2 at one pixel out of every four pixels in the transport direction D2. As a result, three quarters of the pixels constituting the image data have gradation values of C, M, Y, and K1 but no gradation value of K2, while the other one quarter pixels have gradation values of C, M, Y, and K2 but no gradation value of K1. According to step S125 described above, when an image is printed based on the print data that has been subjected to halftone processing of step S150, K to be printed in the image is printed by the nozzles 20 of the nozzle row 26K1 and the nozzles 20 of the nozzle row 26K2 in a shared manner in a proportion of 75:25. Therefore, according to step S125, the usage ratio of the nozzles 20 of the nozzle row 26K1 is 75%, and the usage ratio of the nozzles 20 of the nozzle row 26K2 is 25%, hence D3=50%. Proceeding from the “Medium degree” determination of step S120 to step S125 consequently corresponds to performing printing in accordance with the “third printing mode”.

The idea of including the third printing mode is of course equally applicable to the flowchart of FIG. 5. In other words, in step S120 of FIG. 5 as well, the control unit 11 determines whether the degree of noticeability of wind ripples described above is “Small degree”, “Medium degree”, or “Large degree”. If it is “Medium degree”, the control unit 11 selects the third printing mode and proceeds to step S144. If the third printing mode has been selected, in step S152, the control unit 11 determines to allocate K data in, for example, 75% of the pixels of the image data after halftone processing to the nozzles 20 of the nozzle row 26K1, and allocate K data in the remaining pixels of the total pixels to the nozzles 20 of the nozzle row 26K2. According to this determination, the usage ratio of the nozzles 20 of the nozzle row 26K1 is 75%, and the usage ratio of the nozzles 20 of the nozzle row 26K2 is 25%, hence D3=50%.

According to such a modified example, the use of the nozzles 20 in the first nozzle row and the use of the nozzles 20 in the second nozzle row can be more finely controlled in accordance with the degree of noticeability of wind ripples.

In addition to reciprocating movement along the main scanning direction D1, the carriage 18 may also be capable of reciprocating along the transport direction D2. In such a configuration, after a pass by forward movement or backward movement along the main scanning direction D1, the carriage 18 moves upstream in the transport direction D2 by a distance corresponding to a single paper feed before performing the next pass. This makes it possible to change the relative positions of the printing medium 30 and the printing head 19 in the transport direction D2, and two-dimensionally perform printing on the printing medium 30 in a stationary state.

In the present embodiment, the order of steps in the flowcharts may be changed as appropriate as long as the advantageous effects of the present disclosure are exhibited. For example, in step S120 in the fifth example, whether the proportion of the amount of the ink of the same color to the total amount of ink to be ejected is greater than or equal to the proportion threshold may be determined based on the image data acquired in step S100. However, the control unit 11 may perform such determination after color conversion processing. This makes it possible to make a determination based on the actual usage ratio of ink rather than a usage ratio of ink that can be predicted from the image data.

Furthermore, the control unit 11 may perform processing for switching printing modes in any of the image processing steps after color conversion. For example, such processing may be performed at the time of changing the dither mask in halftone processing or the like.

Further, the selection of printing modes in accordance with printing conditions according to the present embodiment is not limited to the selection for the entire image represented by the image data. For example, the selection of printing modes may be the selection in a unit of region subjected to printing in a pass by the printing head 19. In the fifth example in particular, the proportion of the ink amount of, for example, K to the total amount of ink to be ejected based on the image data is different region by region. Thus, the control unit 11 may determine, for each region, whether the proportion of the ink amount of, for example, K to the total amount of ink in the region is greater than or equal to the proportion threshold, and switch the printing mode for each region in accordance with the determination for each region before performing printing.

The content of the present embodiment is not limited to the printing apparatus 10 or systems, and may be considered as a disclosure belonging to various categories, such as a method performed by these devices or systems, and a program 12 that causes a processor to perform the method.

What is claimed is:

1. A printing apparatus comprising:
a printing head including a first nozzle row in which a plurality of nozzles configured to eject ink are arranged in a predetermined nozzle row direction, and a second nozzle row in which a plurality of nozzles configured to eject ink of the same color as that of the ink are arranged in the nozzle row direction; and
a control unit configured to perform printing by selecting a printing mode in accordance with a printing condition, and controlling ink ejection onto a printing medium by the printing head based on the selected printing mode;
wherein the printing mode includes a first printing mode and a second printing mode,
wherein D1>D2, where D1 is a difference between a usage ratio of the plurality of nozzles of the first nozzle row and a usage ratio of the plurality of nozzles of the second nozzle row when printing is performed in the first printing mode, and D2 is a difference between a usage ratio of the plurality of nozzles of the first nozzle row and a usage ratio of the plurality of nozzles of the second nozzle row when printing is performed in the second printing mode, and
wherein the control unit performs printing in the second printing mode when printing is performed under a printing condition that tends to make wind ripples noticeable when printing is performed in the first printing mode.

2. The printing apparatus according to claim 1, wherein
each of the plurality of nozzles of the first nozzle row ejects pigment ink and
each of the plurality of nozzles of the second nozzle row ejects dye ink of the same color as that of the pigment ink.

3. The printing apparatus according to claim 1, wherein the control unit performs printing in the second printing mode when the printing condition is a printing condition in which a first gap that is a distance between the printing head and the printing medium is greater than or equal to a predetermined threshold for the first gap.

4. The printing apparatus according to claim 1, comprising
a platen configured to support the printing medium, wherein
the control unit performs printing in the second printing mode when the printing condition is a printing condition in which a second gap that is a distance between the printing head and the platen is greater than or equal to a predetermined threshold for the second gap.

5. The printing apparatus according to claim 1, wherein the control unit performs printing in the second printing mode when the printing condition is a printing condition in which a driving frequency of the plurality of nozzles in the printing head is greater than or equal to a predetermined threshold for the driving frequency.

6. The printing apparatus according to claim 1, wherein
the control unit performs printing in the first printing mode when a first printing medium is used as the printing medium and
the control unit performs printing in the second printing mode when the printing condition is a printing condition in which a second printing medium having a property of being more resistant to ink bleed-through than the first printing medium is used as the printing medium.

7. The printing apparatus according to claim 1, wherein
the control unit performs printing based on image data and
the control unit performs printing in the second printing mode when the printing condition is a printing condition in which a proportion of an amount of the ink of the same color to a total amount of ink to be ejected based on the image data is greater than or equal to a predetermined threshold for the amount of ink.

8. The printing apparatus according to claim 1, wherein each of the plurality of nozzles of the first nozzle row and each of the plurality of nozzles of the second nozzle row eject black ink.

9. The printing apparatus according to claim 1, wherein
the printing mode further includes a third printing mode,
the control unit controls ink ejection so as to satisfy D1>D3>D2, where D3 is a difference between a usage ratio of the plurality of nozzles of the first nozzle row and a usage ratio of the plurality of nozzles of the second nozzle row when printing is performed in the third printing mode, and
the control unit performs printing in the third printing mode in a case of a printing condition that tends to make wind ripples more noticeable than a printing condition under which printing is performed in the first printing mode, and that tends to make wind ripples less noticeable than a printing condition under which printing is performed in the second printing mode.
